(19) United States
(12) Patent Application Publication
(10) Pub. No.: US 2022/0295837 A1
(43) Pub. Date: Sep. 22, 2022

(54) PLANTAIN FOOD PRODUCT AND PROCESSES FOR PRODUCING PLANTAIN FOOD PRODUCT

(71) Applicant: Thelma OVIASU, Old Westbury, NY (US)

(72) Inventor: Thelma OVIASU, Old Westbury, NY (US)

(21) Appl. No.: 17/833,546

(22) Filed: Jun. 6, 2022

Related U.S. Application Data
(63) Continuation of application No. 16/596,425, filed on Oct. 8, 2019, now abandoned.
Application No. 16/596,425 is a continuation of application No. 14/460,792, filed on Aug. 15, 2014, now abandoned.
(60) Provisional application No. 61/866,051, filed on Aug. 15, 2013.
(60) Provisional application No. 61/880,928, filed on Sep. 22, 2013.
(60) Provisional application No. 61/880,994, filed on Sep. 23, 2013.
(60) Provisional application No. 61/888,275, filed on Oct. 8, 2013.
(60) Provisional application No. 61/904,474, filed on Nov. 15, 2013.
(60) Provisional application No. 61/905,090, filed on Nov. 15, 2013.

(51) Int. Cl. A23L 7/10; A23L 19/10; A23L 11/00; A23L 19/00; A23L 19/12

(52) U.S. Cl. CPC A23L 7/10; A23L 19/10; A23L 19/11; A23L 11/05; A23L 19/105; A23L 19/09; A23L 19/13

(57) ABSTRACT

The invention comprises various embodiments of processes by which cookable food product may be prepared and the consumable product that may be made through the uses of those processes. Advantageously, a food product may be made through the processes that is lower starch and more nutritious than food product made through conventional food processes. The system and methods may be used to make a cookable food product and a consumable food product from plantain or another type of starchy fruit or vegetable.

### CROSS-REFERENCE TO RELATED APPLICATIONS

This application is a continuation application of U.S. patent application Ser. No. 16/596,425, filed Oct. 8, 2019, which claims priority to U.S. patent application Ser. No. 14/460,792, filed Aug. 15, 2014, which claims priority to U.S. Provisional Patent Application No. 61/866,051 filed Aug. 15, 2013, U.S. Provisional Patent Application No. 61/880,928 filed Sep. 22, 2013, U.S. Provisional Patent Application No. 61/880,994 filed Sep. 23, 2013, U.S. Provisional Patent Application No. 61/888,275 filed Oct. 8, 2013, U.S. Provisional Patent Application No. 61/904,474 filed Nov. 15, 2013, and U.S. Provisional Patent Application No. 61/905,090 filed Nov. 15, 2013, which are incorporated by reference in their entirety.

### FIELD OF THE INVENTION

The present invention relates generally to plantain food product and processes for preparing such product. More specifically, the present invention relates to a cookable plantain food product and the processes by which it may be made from plantain or one or more starchy fruit or vegetable. The present invention is directed also to the processes by which a consumable plantain food product may be prepared through the shaping and the cooking of the cookable plantain food product. Advantageously, certain process embodiments are directed to the removal of plantain starch and can be used to produce a consumable food product that is lower in starch, and therefore lower in carbohydrates and calories relative to food product made through conventional processes yet nutritious. Other process embodiments are directed to the preparation of a cookable plantain food product to which may be added one or more additional food components—including one or more liquids, seasonings, vitamins, minerals, or whole food product, such as legumes, fruit, vegetables or grains—prior to cooking in order to manage and enhance the texture, appearance, flavor, aroma, taste, and nutrition level of the consumable food product.

### BACKGROUND OF THE INVENTION

Plantain (Musa paradisciaca) is indigenous to the tropical regions of the world. The plant produces fruit year round. The fruit is considered to be a reliable all-season staple food crop. Plantain fruit serves as the tenth most important staple food in the world. The plantain fruit is reported as having an average energy value of 115 kCal/100 mg of pulp. It is also known that plantains are rich in starch, dietary fiber, and a number of minerals including phosphorous, calcium, iron, potassium, magnesium, manganese, copper, iodine, zinc, and cobalt. Plantains also serve as a good source of vitamins A, B6, and C. More than 25% of the food energy requirements of Africa is thought to be met by plantains and bananas. In Uganda, for example, an average per-capita consumption of 242 kg of bananas and plantains was reported in 1996.

The plantain fruit includes a peel, the color of which often provides an indication of the character of the pulp encased within the peel. When plantains are not yet fully ripe, the peel is green and often very stiff and the pulp is hard and starchy tasting. When plantains are ripe, the peel is more yellow in color and can be removed—in much the same way a dessert banana is peeled—to reveal a softer pulp. The softer pulp is caused by the conversion of starch to sugar. However, because only very ripe plantains are sweet and therefore may be consumed like a banana in an uncooked state, most plantains are cooked.

There are many known methods by which plantains are made ready for cooking and cooked for consumption. Plantain fruit can be boiled, roasted, or baked. Plantain fruit can also be dried and then ground into a flour from which gruel is made. Additionally, food may be prepared from plantain fruit by removing the peel of the less ripe fruit, slicing it, and deep-frying the slices in hot oil. Fried plantain slices are typically very starchy, similar to potatoes, and are often referred to as “chips”. Food may be made from plantains also by simply adding water to the plantain fruit, mashing the mixture, and cooking it. Among the efforts to produce a consumable food product from plantains or a similar type of starchy fruit or vegetable are those described in the following patents and patent applications.

Lima et al. (U.S. Pat. No. 3,510,314) discloses methods of preparing banana chips in thin, wafer form from unpeeled, unripe bananas by cross-slicing them in thin slices, deep-fat frying the slices in oil, then deoiling and drying them.

Nunez (U.S. Pat. No. 4,935,254) discloses a process for producing banana flavored chips by coating fried banana chips with a mixture of banana puree and sugar and quick frying the coated banana chips a second time.

Fichtali et al. (U.S. Pat. No. 5,855,688) discloses a process for the production of food grade starch by the communition of unpeeled, unripe, green bananas, wet milling the banana with a lye solution, holding it for at least one hour, diluting it with water, and screening it, the crude starch solution from which is then concentrated and purified to produce a purified starch solution which is then neutralized and dewatered, and dried.

Al-Hakkak (U.S. Pat. No. 7,001,469) discloses a process of producing starch from plant material by producing a flour from peeled, green bananas, mixing the banana flour with gluten and salt, steeping the dough in water and kneading it to release the starch into the water, rewashing the dough, combining and filtering the wash waters, then separating the starch from the filtered wash including by decantation, centrifugation, filtration, or evaporation to produce a banana starch.

Zirkia (U.S. Pat. No. 8,568,820) discloses methods for treating starch-containing product including banana to remove soluble starch, the methods including the steps of mixing the product with water, raising the temperature of the mixture, maintaining the temperature of the mixture for a period of time, then filtering the mixture to remove the water containing the starch. The high caloric value, soluble starches that are removed from the food product may be used to manufacture high glycemic index foods and other purposes.

Ashourian et al. (U.S. Patent Application Publication No. 2009/0304865) discloses methods of making low-fat or fat-free snack food products from cut or shaped plantain pieces by cleaning, cutting, forming or shaping, and preferably contacting the pieces with an aqueous solution such as water to remove free starch, then baking, frying, or drying the pieces.

Campbell et al. (U.S. Patent Application Publication No. 2010/0215826) discloses a snack cracker and methods for making same from a pureed fruit, such as banana, to form a dough that may be cooked.

Han (U.S. Patent Application Publication No. 2013/0156893) discloses methods for manufacturing a plantain puree through processes that include heat treatment such that the product can be used for purposes including as a sugar replacer.

There are many drawbacks associated with the many known methods for producing a consumable food product from plantains or another starchy fruit or vegetable. For example, many such known methods require the expenditure of large amounts of time and labor and some type of fuel to produce a consumable food product. Also, many of the known methods produce a consumable food product that has limited nutritional value since the vitamin and mineral content of the fruit or vegetable is often depleted during the course of processing. Additionally, many known methods for making a consumable food product from a starchy fruit or vegetable produce an end product that has high levels of starch and sugars. Foods with such compositions are problematic for diabetics since the complex carbohydrates quickly convert to simple sugars after consumption. These simple sugars cause a rapid and large rise in blood glucose levels. Continuous high glucose levels may lead to damage in the body and the other potential health problems associated with diabetes. Diabetes is a domestic and worldwide problem. According to the American Diabetes Association, currently in the United States 79 million people have prediabetes and 26 million have diabetes. The medical journal Lancet reports that the number of adults with diabetes in 2008 was more than double the number in 1980 and the number of adults with diabetes world-wide in 2008 was reported at 247 million. People with prediabetes are five to six times more likely to develop diabetes over time and prediabetes or diabetes also increases the risk for cardiovascular disease, strokes, high blood pressure, kidney disease and blindness. However, because only 5% of adult diabetes are Type I, the remaining population of adult diabetics are considered to have a preventable, treatable, curable condition mainly based on proper nutrition and exercise. With plantains serving as the tenth most important staple food that feeds the world, combined with the growing worldwide need to improve nutritional intake, it is critical that a wider range of foods be identified that have less complex carbohydrates that quickly convert to simple sugars after consumption and are nutritional.

A demand therefore exists by which a consumable food product can be made from plantains or another starchy fruit or vegetable quickly and easily and that is lower in starch, lower in carbohydrates and calories, yet nutritious and flavorful. The present invention satisfies this demand.

### SUMMARY OF THE INVENTION

Certain embodiments of the present invention are directed to a process by which a cookable plantain food product and a consumable food product may be made. Advantageously, embodiments of the invention described in this application may be used to produce a cookable food product and consumable food product from plantain or another starchy fruit and vegetable. In addition to plantain, such other starchy fruit and vegetable includes but is not limited to bananas, corn, yam, African sweet potatoes, rice, cow peas, black eye peas, red beans, chickpeas, potatoes, cassava, and cocoa yams. These starchy fruits and vegetables will be termed “starchy vegetable” for purposes of this application. Accordingly, while the following describe the inventive system and methods by discussing plantain, the invention has applicability to the production of a cookable food product and a consumable food product from one or more of such other starchy vegetables. Advantageously, through the use of certain embodiments of the process a wide range of starchy vegetables—that is, those that may be unripe, ripe, or a combination of unripe and ripe—can be used.

In certain embodiments in which the starchy vegetable has a peel, such as plantain fruit, the vegetable is peeled. If the starchy vegetable that is used has no peel, the peeling step would be unnecessary. However, another pre-processing step may be required in order to obtain for processing the portion of the starchy vegetable that is typically used as a food. For example, corn is a starchy vegetable that would require the removal of the husk and the removal of the corn kernels from the cob. The starchy vegetable is then processed—through one or more chopping, grinding, and rotating steps—to form a mash.

By reference to plantain as a representative starchy vegetable, some other liquid, such as but not limited to fresh water, may be added to the peeled plantain before or during the course of the mashing process to produce plantain mash having the desired moisture content. In either certain embodiments—that is, in either those embodiments to which a liquid has been added or those embodiments to which liquid has not been added —, liquid may then be removed from the plantain mash to produce a drier plantain mash and an amount of removed liquid. In certain embodiments, water or another liquid may be then added to and mixed with the drier plantain mash and an amount of liquid again removed. These steps of removing liquid from the plantain mash, adding a new amount of liquid—termed “fresh liquid”- to the drier plantain mash, mixing, and removing an amount of liquid from the resultant mash may be repeated as desired. Some or all of the liquid that is removed from the plantain mash—termed “removed liquid”—is preferably retained because it contains quantities of the important minerals and vitamins found in the plantain. However, because the removed liquid can also contain what may be considered to be in certain applications the less desirable starch component found in the plantain or other starchy vegetable, certain embodiments of the present invention include one or more steps by which starch is separated from the removed liquid. The separation process may separate the starch in the form of a liquid or another form, including a pellet. The removed liquid from which the starch is separated—termed “plantain liquid supernatant” or “supernatant” for purposes of this application—may be returned to the drier plantain mash—rather than, for example, a fresh liquid—in order to produce a plantain mash that is enhanced. For purposes of this application, the term “enhanced plantain mash” or “enhanced mash” shall mean that which results when components removed from the plantain or other starchy vegetable are added to the mash to produce a mash having a composition that is different from the original mash and includes a higher level of certain desired components relative to other components. When supernatant is added back to the drier mash, the resultant enhanced mash has higher nutrition levels and lower levels of starch compared to a mash that was simply washed with water. Such an enhanced mash may be used as a cookable food product to produce a lower carbohydrate, lower calorie, nutritious, healthy, and flavorful consumable food product.

In other certain embodiments of the present invention, ripe plantain (or another starchy vegetable) is used. Such ripe product is sweeter than green or partially ripe product because the starch in the product pulp is converted to sugar. Ripe plantain is also very easily digested. As the plantain ripens, it has been found that there is a significant increase in amino acids, which are important to maintain human health. While sweeter, ripe plantains are, however, also soft and cannot easily be used to make certain consumable plantain food products. For example, a soft, ripe plantain cannot easily be cut into slices and fried to make the crunchy plantain chips that are a popular plantain food product. In certain embodiments of the present invention, the ripe plantain is mashed, liquid removed from the mash, and, by returning the plantain liquid supernatant to the drier mash, an enhanced mash may be prepared from which a cookable plantain food product may be produced. In certain other embodiments, the starch that was removed during the separate processing of unripe or partially ripe plantains—such as by, for example, the processes described above—may be added to the enhanced mash. This starch that may be removed during the separate processing of a different batch of plantains is termed “new starch” for purposes of this application. The addition of the new starch to the mash produces a starch enhanced mash that is easier to manage, shape, and package as a cookable plantain food product compared to a mash not having the new starch. Also a cookable plantain food product made from such a starch enhanced mash—that is one made from ripe plantain and with the starch added from that which is removed from other plantain—is sweet because of the sweetness of ripe plantain and not added sugar or other sweeteners, is gluten free because no flour is needed to improve the manageability of the mash, and can be made crunchy due to the added starch.

Certain embodiments of the process by which a cookable food product is prepared include the step or steps in which one or more food components—including seasonings, vitamins, minerals, or whole food product, such as legumes, fruit, vegetables or grains—are blended with the enhanced mash to complement and manage the texture, appearance, flavor, aroma, taste, and/or nutrition level of the enhanced mash and produce a complemented cookable food product from which can be prepared a consumable food product.

Certain embodiments of the present invention include the step of preparing a shaped cookable food product. In one certain embodiment for preparing a shaped cookable plantain food product, other additives, such as leavening agents and oil, may be added to the enhanced mash and the mash steamed or otherwise heated and blended to make it more malleable—that is, more elastic, stretchable, and manageable—for shaping.

Advantageously, the shaped cookable plantain food product may be configured to provide one or more additional benefits. For example, the shaped cookable plantain food product may be configured to facilitate the packaging, distribution, and storage of the product. The shaped cookable plantain food product may be configured to facilitate more efficient cooking of the product. The shaped cookable plantain food product may be configured to facilitate the production of a consumable food product that is of a desired size and shape and has a generally consistent taste, texture, and flavor profile.

One benefit of this invention is that it may facilitate the conservation of food since embodiments of the invention can utilize a range of plantain or other starchy vegetable—even those that may be considered to be overly ripe for purposes of conventional processing methods.

Another benefit of this invention is that certain embodiments permit the production of a consumable food product that may be lower in starch, and therefore, lower in carbohydrates and calories than food products made through conventional processing methods.

An additional benefit of this invention is that certain embodiments facilitate the production of a consumable food product that may be more nutritious than food products made through conventional processing methods.

Another benefit of this invention is that certain embodiments facilitate the production of a consumable food product that may be more flavorful than food products made through conventional processing methods.

An added benefit of this invention is that certain embodiments facilitate the production of a consumable food product that may be sweet but does not include any added sugar or sweeteners.

A further benefit of this invention is that certain embodiments facilitate the production of a consumable food product that is gluten free.

An added benefit of this invention is that certain embodiments facilitate the production of consumable food product that are made wholly from plantain or another type of starchy vegetable.

Another benefit of this invention is that certain embodiments can permit the addition of one or more food components—including additional seasonings, vitamins, minerals, or whole food products, such as legumes, fruit, vegetables or grains—in order to produce a wide range of consumable food products, including products having different nutrition, health, and flavor profiles.

The present invention and its attributes and advantages will be further understood and appreciated with reference to the detailed description below of presently contemplated embodiments, taken in conjunction with the accompanying drawings.

### BRIEF DESCRIPTION OF THE DRAWINGS

FIG. 1 illustrates a flow chart of one of the preferred embodiments of the invention by which a cookable plantain food product may be produced

FIG. 2 illustrates a flow chart of one of the preferred embodiments of the invention by which a cookable plantain food product may be produced;

FIG. 3 illustrates a flow chart of one of the preferred embodiments of the invention by which a cookable plantain food product may be produced;

FIG. 4 illustrates a flow chart of one of the preferred embodiments of the invention by which a cookable plantain food product may be produced;

FIG. 5 illustrates a flow chart of one of the preferred embodiments of the invention by which a cookable plantain food product may be produced

FIG. 6 illustrates a flow chart of one of the preferred embodiments of the invention by which a consumable plantain food product may be produced; and

FIG. 7 illustrates a flow chart of one of the preferred embodiments of the invention by which a consumable plantain food product may be produced.

### DETAILED DESCRIPTION OF EMBODIMENTS OF THE INVENTION

In the following description, for purposes of explanation, specific numbers, materials, and configurations are set out in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to “one embodiment” or “an embodiment” means that a particular feature, structure or characteristic described in connection with the embodiment is included in at least one embodiment of the invention. The appearances of the phrase “in one embodiment” in various places in the specification are not necessarily all referring to the same embodiment.

Certain embodiments of the present invention are directed to a process by which a cookable plantain food product may be made. The term “cookable plantain food product” includes that which may be produced from one or more of the following described processes and that may be used promptly, or stored, packaged, and/or distributed for later use to prepare a consumable food product. Certain other embodiments provide a process by which consumable food products may be prepared from the embodiments of the cookable food product. The present invention also includes certain embodiments of the cookable food product. Additionally, the present invention includes certain embodiments of the consumable food product.

The following description and drawings will make reference to plantain. However, embodiments of the present invention may be used to produce cookable food product and consumable food product from another type of starchy fruits and vegetables including but not limited to bananas, corn, yam, African sweet potatoes, rice, cow peas, black eye peas, red beans, chick peas, potatoes, cassava, and cocoa yams. These other starchy fruits and vegetables will be termed “starchy vegetable” for purposes of this application.

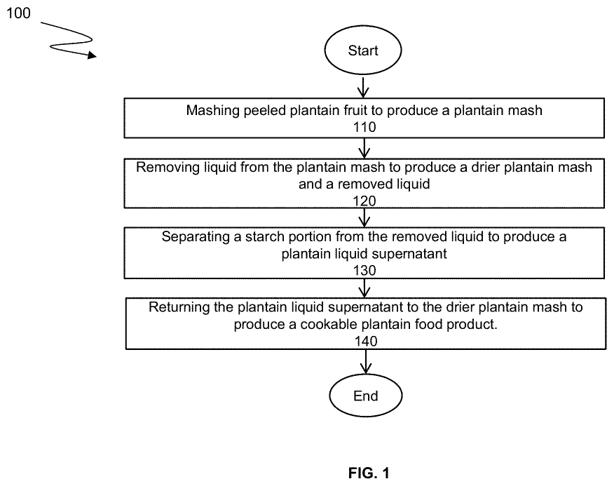

FIG. 1 illustrates a flow chart 100 of one of the preferred embodiments of the present invention of a process by which a cookable plantain food product may be produced. To produce a cookable plantain food product according to the process illustrated in FIG. 1, one or more plantains are peeled and then mashed to produce a plantain mash 110. A variety of methods may be used to mash the peeled plantains including chopping, grinding, mixing, and blending. Accordingly, for purposes of this application, the term “mash” does not mean that only one or more conventional processes by which a mash is typically produced—that is, beating, crushing, and/or mixing—will be used or that water or some other liquid will always be mixed with the plantain or that heat or some other method of cooking will be applied or utilized. Advantageously, certain embodiments of the present invention may use plantains that may be unripe, ripe, or a combination of unripe and ripe.

According to the embodiment shown in FIG. 1, liquid is removed from the plantain mash to produce a drier plantain mash and a removed liquid 120. To remove the liquid from the plantain mash, a variety of methods may be used. For example, the plantain mash may be suspended on a material—including, but not limited to metal or plastic mesh, cheese cloth, paper, or cloth filter—and the liquid allowed to drip from the mash. The plantain mash may also be confined in some volume such as with a different material and pressure applied—for example, by hand or by a mechanical press—to squeeze out the liquid. Alternatively, the plantain mash may be spun and, by this spinning process, the liquid drawn from the mash.

The removed liquid produced through step 120 is preferably retained because it contains quantities of the important minerals and vitamins found in plantain fruit. However, the removed liquid also contains starch. The embodiment of the process illustrated in FIG. 1 includes separating a starch portion from the removed liquid to produce also a plantain liquid supernatant 130—also termed a “low starch liquid supernatant”. A variety of methods may be used to accomplish the separation of a starch portion from the liquid. For example, the removed liquid may be allowed to remain in a container in a non-agitated state for a period of time that is sufficient to permit the generally heavier starch component to settle to the bottom of the container and the plantain liquid supernatant to stratify in an above layer. A starch portion may be separated from the removed liquid, for example, by drawing off the plantain liquid supernatant from the higher starch liquid portion. The starch portion can thereby be segregated and managed as needed. As an alternative to or as an addition to the previously described passive method of performing the separation, the removed liquid may be rotated such that the generally heavier starch component is layered, clumped, or pelleted generally separate from the remaining portion of the removed liquid. Upon the separation and removal of the starch from the removed liquid, the remaining portion of the removed liquid—the “plantain liquid supernatant”—will include less starch relative to the removed liquid.

The embodiment of the process illustrated in FIG. 1 includes returning the plantain liquid supernatant to the drier plantain mash to produce an enhanced plantain mash and thereby a cookable plantain food product 140. Advantageously, by returning the plantain liquid supernatant to the drier plantain mash, some of the minerals and vitamins that were captured in the liquid that was removed during the removal step, may be added back to the plantain mash but now without amounts of the starch. As a result, the enhanced plantain mash is nutritious and has less starch, fewer carbohydrates, and fewer calories than plantain mash simply produced by the mashing of plantains with water or the mashing of plantains and washing the mash with water.

TABLE 1

| | | | | | |
|---|---|---|---|---|---|
| | | | | | De-Starched |
| | | Raw Plantains | De-Starched | Plantain | Plantain with |
| | | USDA Value | Plantain Pulp | Liquid | Liquid |
| Nutrient | Unit | per 100 g | Value per 100 g | Supernatant | Supernatant |

Proximates

| | | | | | |
|---|---|---|---|---|---|
| Energy | kcal | 122 | 50.8 | 3.81 | 55.5 |
| Protein | g | 1.3 | 0.372 | 0.423 | 0.591 |
| Total lipid (fat) | g | 0.37 | 0.026 | 0.006 | 0.071 |
| Carbohydrate, by | g | 31.89 | 12.3 | 0.5 | 13.1 |
| difference | | | | | |
| Fiber, total dietary | g | 2.3 | 2.38 | <0.75 | 1.48 |
| Sugars, total | g | 15 | <0.1 g | 0.3 | <0.1 |

Minerals

| | | | | | |
|---|---|---|---|---|---|
| Calcium, Ca | mg | 3 | 19.5 | 1.51 | 15.1 |
| Iron, Fe | mg | 0.6 | 0.137 | <0.0500 | 0.187 |
| Magnesium, Mg | mg | 37 | 4.45 | 28.9 | 23.2 |
| Potassium, K | mg | 499 | <4.93 | 328 | 207 |
| Sodium, Na | mg | 4 | <4.93 | <2.50 | <2.48 |

Vitamins

| | | | | | |
|---|---|---|---|---|---|
| Vitamin C, total | mg | 18.4 | 5 | 5.8 | <1.0 |
| ascorbic acid | | | | | |
| Vitamin A, RAE * | μg | 56 | see below | see below | see below |
| Vitamin A, IU * | IU | 1127 | see below | see below | see below |

Lipids

| Fatty acids, total | g | 0.143 | 0.012 | | 0.003 | 0.022 |
|---|---|---|---|---|---|---|
| saturated | | | | | | |
| Fatty acids, total | g | 0.032 | <0.007 | | <0.002 | 0.016 |
| monounsaturated | | | | | | |
| Fatty acids, total | g | 0.069 | 0.013 | | 0.003 | 0.031 |
| polyunsaturated | | | | | | |
| Cholesterol | mg | 0 | <1.00 | | <1.00 | <1.00 |
| * Total Vitamin A | | | 84 | IU | 175 IU | 382 IU |
| Vitamin A from | | | <100 | IU | <100 IU | <100 IU |
| Retinol | | | | | | |
| Vitamin A From | | | 84.4 | IU | 175 IU | 382 IU |
| Carotene | | | | | | |

Table 1 above provides various information regarding raw plantains and plantains processed through the described steps to produce a lower starch, lower calorie, and lower carbohydrate cookable plantain food product. The column of Table 1 titled “Raw Plantains USDA Value per 100 g” provides nutrition data from the National Nutrient Database (Standard Reference Release 26) of the National Agricultural Library for raw, green, peeled plantains. The second column—titled “De-Starched Plantain Pulp Value per 100 g”—provides nutrition data for the drier plantain mash processed according to the inventive steps—that is, a plantain processed according to the described methods to produce a plantain mash from which liquid has been removed. The third column provides nutrition data for the plantain liquid supernatant—that is, the liquid removed from the plantain mash and from which a starch portion has been removed to produce the drier plantain mash. The fourth column provides nutrition data for the “de-starched” plantain mash but with the plantain liquid supernatant added back.

The Table 1 data shows that by removing the starch, the plantain mash is lower in carbohydrates and calories than raw plantain. The data shows also that the liquid removed from plantain mash—which in many conventional processes is not retained—includes significant levels of protein, vitamins, and minerals. The data shows also that when the liquid supernatant is added back to the de-starched mash, the nutritional level of the mash increases without significantly increasing the carbohydrates and calories and therefore permitting a low starch, low carbohydrate, low calorie, yet nutritious cookable plantain food product to be manufactured.

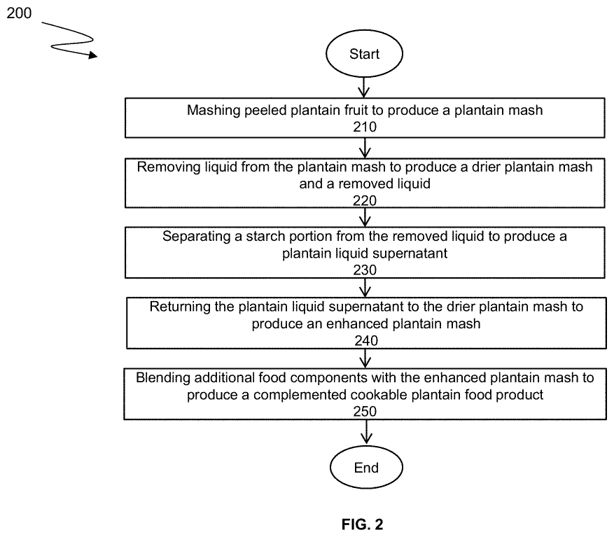

FIG. 2 illustrates an embodiment of the process that largely includes many of the steps of the process embodiment illustrated in FIG. 1. The embodiment of the process illustrated in FIG. 2, however, differs as following. The FIG. 2 embodiment does, like the FIG. 1 embodiment, include returning the plantain liquid supernatant to the drier plantain mash to produce an enhanced plantain mash 240. However, a blending step 250 is added in which one or more food components are introduced to the enhanced plantain mash to produce a complemented cookable plantain food product. For purposes of this application, the term “blending” is not limited to simply the step of mixing the food components into the enhanced plantain mash but may comprise or include one or more other steps including the “dusting”, coating, covering, applying, inserting, or layering of one or more food components with the enhanced plantain mash 240 or the curing or soaking the enhanced plantain mash with one or more food components. Certain food components that may be added to the enhanced plantain mash may include leavening agents, oil, and/or vinegar and possibly some additional fresh water to alter the moisture content of the mash. Alternatively, or in addition, other flavorings, seasonings, or components may be blended with the enhanced plantain mash including but not limited to the following: sesame seeds, coconut chips or flakes, chocolate chips, peanut or other nut butter or powder, chili pepper, fruit juice, flour, other spices and seasonings, vitamins, minerals or whole food product, such as legumes, fruit, vegetables or grains. A cookable plantain food product can be prepared as a result of the blending step 250 that can satisfy a wide variety of needs and purposes and from which a consumable plantain food product can be produced having a wide range of texture, appearance, and nutrition levels and flavor, aroma, and taste profiles.

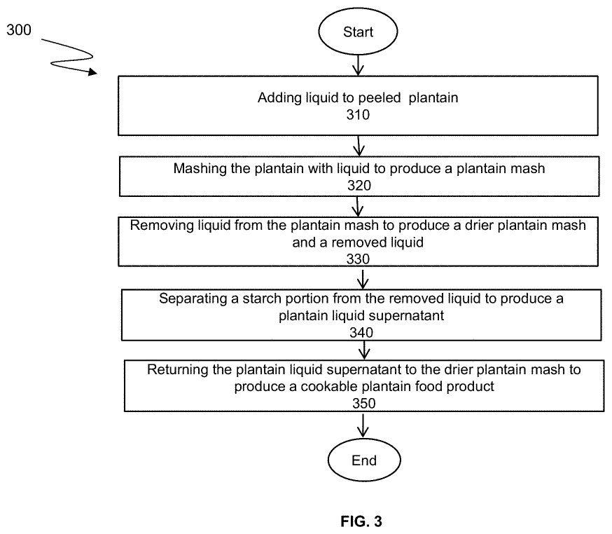

FIG. 3 illustrates an embodiment of a process much like the processes illustrated in FIG. 1 and FIG. 2. The FIG. 3 process, however, includes a first step in which liquid is added to peeled plantain to produce a plantain mash 310. The liquid may be, but is not limited to fresh water. This step may be advantageous in that the addition of the liquid to the plantain and the mashing of the mixture to produce a plantain mash 320 may cause a greater amount of starch to go into solution and thereby be present in the removed liquid so that the starch is separable from the removed liquid during step 340 to produce a cookable plantain food product that is lower in starch. In addition, a blending step—such as the one 250 described above with respect to the FIG. 2 process—may be added to the process shown in FIG. 3 so that one or more additional food components may be blended with the drier plantain mash to which is added the plantain liquid supernatant is added in order to produce a cookable plantain food product having widely different qualities and characteristics.

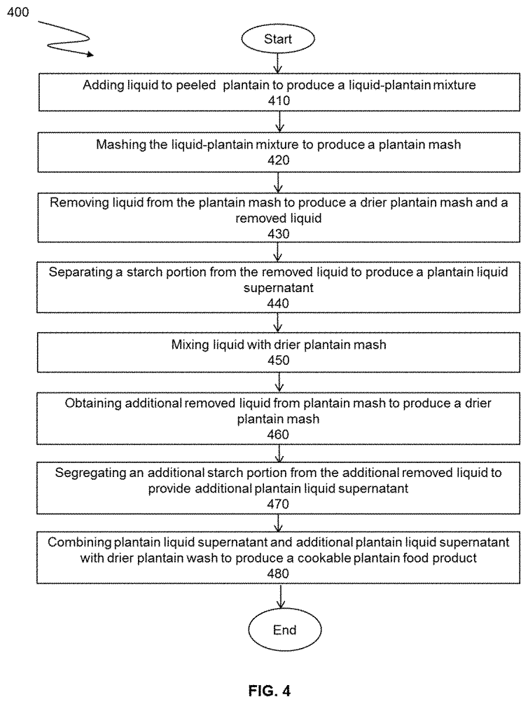

FIG. 4 illustrates an embodiment of a process much like the above described processes. The FIG. 4 process, however, includes a step in which liquid is added to and mixed with the drier plantain mash 450 and a step in which additional liquid is removed from the plantain mash (the “additional removed liquid”) to produce a drier plantain mash 460. The FIG. 4 process includes also a step 470 in which an additional starch portion is removed from the additional removed liquid to produce an additional plantain liquid supernatant—also termed an “additional low starch liquid supernatant”. Step 480 of the FIG. 4 process is combining the plantain liquid supernatant and the additional plantain liquid supernatant to form a combined liquid supernatant and combing that with the drier plantain mash to produce the enhanced plantain mash and therefore a cookable plantain food product. The steps 450 through 470—adding additional liquid to the drier plantain mash, obtaining additional removed liquid from the plantain mash to produce a drier plantain mash, segregating an additional starch portion from the additional removed liquid to provide an additional plantain liquid supernatant—may be repeated as desired so that more and more starch may be removed from the mash but, because the larger and larger amounts of additional plantain liquid supernatant are added back to the mash with the plantain liquid supernatant, amounts of the protein, vitamins, and minerals that were in the beginning plantain mixture are returned to the mash and a cookable plantain food product that is lower in starch yet nutritious is produced. The blending step—that is, adding additional food components to the drier plantain mash described above—may also be used with respect to the FIG. 4 process.

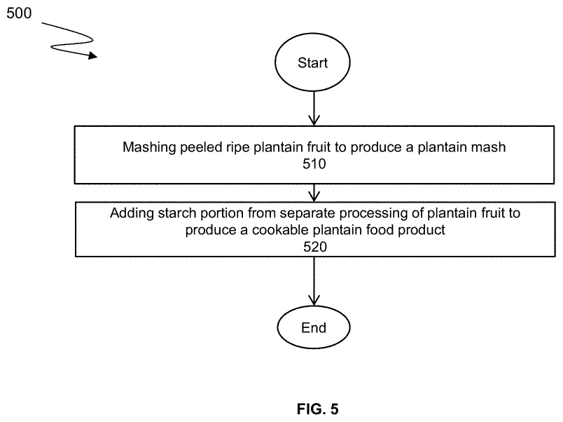

FIG. 5 illustrates another certain embodiment of the present invention in which ripe plantains are preferably used. Ripe plantains are sweeter, softer, and, compared to green or unripe plantains, often do not require added liquid in order to prepare a manageable mash. As a result, the process illustrated in FIG. 5 may include a first step of mashing peeled ripe plantain fruit to produce a uniform plantain mash 510. In order to produce a wide range of cookable plantain fruit products from this mash, the starch that was removed during the separate processing of unripe or partially ripe plantains, for example, according to the processes illustrated in FIG. 1 through FIG. 4—the “new starch”—, may be added to the ripe plantain mash 520. A consumable plantain food product made from the FIG. 5 process may be sweeter than consumable plantain food products made by other conventional processes and the processes illustrated in FIG. 1 through FIG. 4. Additionally, the consumable plantain food product may be gluten free—because no flour is needed to improve the manageability of the mash, and can be made crunchy due to the addition of the new starch.

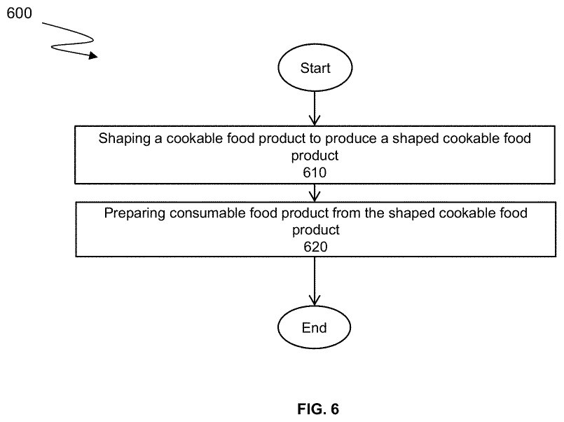

FIG. 6 illustrates a flow chart 600 of an embodiment of the invention by which a consumable food product may be prepared from a cookable food product. The cookable food product may be made from plantain or another type of starchy vegetable, as that termed is defined for purposes of this application. The FIG. 6 process includes a first step of shaping the cookable food product—produced such as through the processes illustrated in FIG. 1 through FIG. 5—to produce a shaped cookable food product 610. To shape the cookable food product, for example, the enhanced mash may be pounded, kneaded, rolled, or subjected to a similar management process so that the mash may be shaped. One such shape is a planar shape. To produce such a planar shape, the enhanced mash is preferably managed to be thin. Such a planar shape may be cut into pieces of any desired shape. In certain embodiments, a formed shape cookable plantain food product may be prepared into a formed shape, such as a parallelepipedal, cylindrical, prismatic, parallelogram sheet. In certain embodiments the formed shape cookable food product may be cut into pieces that represent one or more serving sizes. In certain embodiments the formed shape cookable food product that is cut into multiple serving sizes may then be cut with proliferation, groove or similar cutting slots for future cutting locations or fully cut into individual pieces. The shaped cookable food product may then be additionally seasoned as desired.

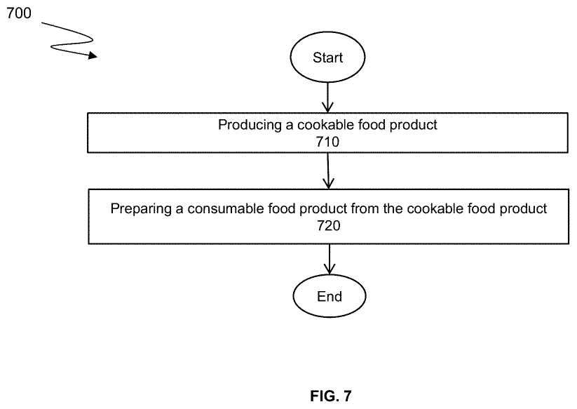

FIG. 7 illustrates one preferred embodiment in which a consumable food product is produced from the cookable food product. The FIG. 7 process includes preparing a cookable food product 710 such as through the processes described in FIG. 1 through 6 by using plantain or another type of starchy vegetable. A variety of processes may be used to accomplish the producing step 720 including baking, frying, grilling, boiling, steaming or similar form of cooking such that the temperature of the cookable food product is increased to undergo a physical transformation by a chemical reaction caused by heat. The cookable food product may be additionally seasoned as desired. The consumable food product may then be served for immediate consumption or stored for consumption at a later time. Alternatively, the consumable food product may be prepared for storage for cooking and consumption at a later time.

While the disclosure is susceptible to various modifications and alternative forms, specific exemplary embodiments of the invention have been shown by way of example in the drawings and have been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

1. A method of producing a low-starch cookable plantain food product comprising the steps of:
(a) mashing a first plantain to product a first plantain mash;
(b) removing a first liquid from the first plantain mash to produce a first drier plantain mash and a first removed liquid;
(c) mashing a second plantain to produce a second plantain mash;
(d) removing a second liquid from the second plantain mash to produce a second drier plantain mash and a second removed liquid;
(e) separating a starch portion from the second removed liquid to produce a plantain liquid supernatant; and
(f) returning the plantain liquid supernatant to the first drier plantain mash to obtain a low-starch cookable plantain mash usable to produce the low-starch cookable plantain food product.

2. The method of producing a low-starch cookable plantain food product according to claim 1 wherein the second plantain is a ripe plantain.

3. The method of producing a low-starch cookable plantain food product according to claim 1, further comprising the steps of:
shaping the cookable plantain food product to produce a shaped cookable plantain food product; and
cooking the shaped cookable plantain food product to produce the consumable plantain food product.
